(19) United States
(12) Patent Application Publication
(10) Pub. No.: US 2005/0234823 A1
(43) Pub. Date: Oct. 20, 2005

(54) Systems and methods to prevent products from counterfeiting and surplus production also of tracking their way of distribution.

(75) Inventor: Rainer Schimpf, Yokohama (JP)

Correspondence Address: RAINER SCHIMPF;GRAND REVE 1004, KOZUKUE - CHO 870-1, KOHOKU-KU, YOKOHAMMA, KANGAWA, 222-0036, JP

(73) Assignee: Rainer Schimpf, Yokohama (JP)

(21) Appl. No.: 10/709,181

(22) Filed: Apr. 20, 2004

(51) Int. Cl. H04L 9/00

(52) U.S. Cl. 705/50

(57) ABSTRACT

A simple and cost effective system of marking products for authentication, preventing surplus production and tracking purpose is described. The system requires computer hardware and software where the calculation and verification of encrypted sequences can be carried out. Depending on the kind of product, its value and production process the economically best solution can be chosen to deliver or affix the encrypted sequence with each peace of product. Authorities, dealer or consumer can proof the authenticity in real-time at any place by verifying encrypted sequences. By testing the consistency of encrypted sequences and subsequent tests by comparing data retrieved from the input device with data stored on a computer system a product can be determined as original or falsification. Subsequent tests are necessary to recognize illegal usage of valid sequences. The result is recorded and reported in real time back to the enquirer or other defined parties.

### CROSS REFERENCE TO RELATED APPLICATIONS

U.S. Pat. No. 6,456,729, September 2002, Moore, 382/103; U.S. Pat. No. 6,226,619, May 2001, Halperin et al., 705/1; U.S. Pat. No. 6,073,121, June 2000, Ramzy, 705/45; U.S. Pat. No. 6,069,955, April 1998, Coppersmith et al., 380/54; U.S. Pat. No. 6,053,406, April 2000, Litman 235/449; U.S. Pat. No. 5,974,150, October 1999, Kaish et al., 713/179; U.S. Pat. No. 5,988,500, November 1999, Litman, 235/450; U.S. Pat. No. 5,267,756, December 1993, Molee et al., 283/86

### BACKGROUND OF INVENTION

1. Field of the Invention

The present invention concerns a system to secure any kind of products against falsifications, more in particular a method and system using coded sequences and logical comparison to determine if a product is an original or a falsification.

2. Background of the Art

Hardly a product is safe against counterfeiting. Always better technical possibilities and more complex methods of the counterfeiters lead to better and faster produce fraudulent falsifications. The conventional recognition characteristics of many marks such as labels and packing no more hurdle for counterfeiters today because beside the product its whole appearance is imitated. For consumers, retailers, wholesale dealers or authorities the distinction between original and falsification is hardly possible at first glance. The subsequences are recessions in sales, liability claims and image loss by brand manufacturers.

It is tried to secure original products against falsifications by using special security characteristics, which require a high technical and financial expenditure and can usually only be manufactured in specialized enterprises. The product, its packing or its accompanying document for example carry one or more substances with security characteristics such as safety thread, which exhibit on visually or by machine controllable physical or chemical characteristic, like fluorescence or magnetism. Also hologram labels represent a further security characteristic, which shows depending on the viewing angle color effects, which cannot be reproduced by copy machines, and which are glued on the product or its packing. Furthermore to the well known measures for the increase of the falsification safeness and for the increase of the recognition rate of falsifications the use of micro text, Guilloch-printing, Kinegram, radio frequency identification (RFID) tag, etc. belongs.

The used security characteristics are however in each case only applicable for a reduced group of products meaningfully as a function of economic, technical, legal or also medical requirements. Technologically complex measures require if necessary special sensors and measuring instruments for the examination of product falsifications, which are not generally available. The simpler and more favorable the production of security characteristics, as faster and easier counterfeiters turns around the technical edge of security characteristics. By the constant advancement of the technology the counterfeiter will be able to copy ever products easier in always-shorter time.

An additional form of counterfeiting happens by outsourcing the manufacturing of products to third parties. The originator risks that third party manufacturer produce more pieces as ordered and bring these products into the market without known by the originator possibly with less quality where these surpluses produced products can hardly be identified as counterfeits. In particular such cases happens when manufacturer are located in areas where the originator is not able to hold the third party liable for.

U.S. Pat. No. 5,267,756 describes a system where an authentication system, method and article for memorabilia and other forms of articles wherein a hologram is affixed to the article with a tamper-proof adhesive. The hologram has thereon a unique code number. A certificate of authenticity is provided with the article and it includes a like or different hologram, but with a matching unique code number. A master record or list of the unique code number and related article to which the code number applies is maintained by an entity, which also provides a registration “hotline.” A purchaser of the article can register that article, and at any time in the future when the article is sold or otherwise transferred its authenticity can be verified through the registration hotline.

U.S. Pat. No. 5,988,500 describes a system where elongated magnetic elements can be inserted into items to provide readable magnetic patterns, which provide reproducible or unique signal patterns to identify or authenticate the items. Magnetic fibers may be distributed within items or magnetic strips to provide reproducible patterns when read. The patterns are stable because of the relatively large size of the magnetic elements as compared to conventional patterns of particles in recordable media. Oriented patterns of filaments may also be inserted into transactional items such as credit cards, checks and the like to provide identification (antiforgery) security to the item.

U.S. Pat. No. 5,974,150 describes an authentication system comprising a medium having a plurality of elements, the elements being distinctive, detectable and disposed in an irregular pattern or having an intrinsic irregularity. Each element is characterized by a determinable attribute distinct from a two-dimensional coordinate representation of simple optical absorption or simple optical reflection intensity. An attribute and position of the plurality of elements, with respect to a positional reference is detected. A processor generates an encrypted message including at least a portion of the attribute and position of the plurality of elements. The encrypted message is recorded in physical association with the medium. The elements are preferably dichroic fibers, and the attribute is preferably a polarization or dichroic axis, which may vary over the length of a fiber. An authentication of the medium based on the encrypted message may be authenticated with a statistical tolerance, based on a vector mapping of the elements of the medium, without requiring a complete image of the medium and elements to be recorded.

U.S. Pat. No. 6,053,406 describes a method for any magnetically readable systems such as credit cards, currency, identification cards, or other transactional items. The information stored on the magnetically readable system is then used for verifying the authenticity of the source of information by comparing a signal from said item with a defined signal and providing a warning signal if the predetermined level of conformity is not achieved or is not exceeded.

U.S. Pat. No. 6,069,955 discloses a method using a visible seal or label containing a serial number is placed in plain view on the product packaging. The visible label contains the serial number as well as a first public key encrypted version of the serial number. A second or hidden label inside of the package has thereon a second encrypted version of the serial number made using a second public key. Only the manufacturer knows the private keys. Using a corresponding public key provided by the manufacturer, the consumer, law enforcement agent, or customs inspector can verify that the encrypted version matches the serial number. Moreover, using a point of sale machine equipped with the public key the sales clerk can authenticate the product in front of the consumer at point of purchase. Additionally, in the case of a CD or other digital medium, the hidden label may comprise a digital watermark of the encrypted serial number such that a consumer, law enforcement agency, or customs inspector can readily detect a counterfeit product.

U.S. Pat. No. 6,073,121 describes a method, which improves check fraud prevention systems both in printing and verifying checks. The method operates by printing on each issued check, a line of encrypted machine-only readable symbols such as a bar-code that contains all the information printed on the check, using a special, key-selectable encryption algorithm. When a check is presented to a bank teller or a cashier, a required, modified reader/decoder device connected to a computer, will read the line of encrypted data and identify a fraudulent check for rejection. The method requires primarily computer software additions and changes.

U.S. Pat. No. 6,226,619 discloses a method and system for preventing counterfeiting of an item include an interrogatable radio frequency identification (RFID) tag attached to the item. The item includes visible indicia for comparison with secret, non-duplicable information stored in the tag designating authenticity.

U.S. Pat. No. 6,456,729 discloses a system and method of marking goods for authentication and tracking purposes is described. The system and method include a central control that enables the system. The method and system are accomplished in real time affording manufacturers the ability to eliminate problems associated with counterfeiting and diversion which begin at one or more manufacturing site which are remote from central control. A central control unit enables the system by providing an allotment of marks to one or more host units. Each host unit directs marking terminals to mark, at locations remote from the host units, particular goods or packages with specific information encoding symbols. Items are preferably marked directly with dyes containing one or more active compounds, but alternately can be identified by means of affixed fixtures, which are marked with encoding symbols either prior to, or subsequent to, affixing to the items. Following marking, items are scanned to insure proper marking. Once within the commerce stream, items can be checked by illuminating the symbols marked thereon and cross referencing this data with the host database by using a field reading unit, or alternately decoded into clear text at the field reader for analysis. A careful detailed review of the above patent disclosures results in the conclusion that although each method may be useful in combating check fraud.

Thus there remains a need for a system and method, which is in principle applicable for all pieces of products and easy to implement into the production process by using an encrypted sequence and deliver it with each piece of product. Only the verification of such a sequence is not the guarantee of an original product because in case of counterfeiting the product and the sequence it will not be recognized as falsification. Therefore the invention has a system and method to determine in real time products as original or as falsification even in cases where valid sequences are copied and used on multiple products.

### SUMMARY OF INVENTION

The present invention is to suggest a global system for protecting products against counterfeiting, surplus production and determining the place where the actual proof of authenticity of a product is carried out which is in principle applicable for all kind of products. In application and conversion it is as simple as possible, small additional requirements to the examinable ness places and is besides economical. The system can be easy implemented in any production process in a similar way as marking products with a serial number or a price tag. In addition the present invention provides a method of tracing the way of distribution of these products that can be beneficial to affirm the truth of the proof of authenticity. The system includes methods of calculating unique, short and high secure encoded sequences by using computer hardware and software. In addition it includes input devices, computer hardware and software, which can be physically linked via any kind of data connections. The encoded unique sequence is further named as unique product-inspection sequence.

Accordingly it is a prime object of the present invention to deliver an encoded sequence with each piece of product, which enables subsequent inspections to proof the authenticity of products. The unique product-protection sequence can be a numerical sequence, alphanumerical sequence, a sequence of alphabetical characters or a bit sequence. The unique product-inspection sequence can be arbitrary delivered with products for example: visible printed or engraved as a sequence of alphanumeric characters or barcode on the product, its package, on a label which is affixed to the product or its package or on an accompanying document; implemented into or affixed to the product or its package by using a radio frequency identification (RFID) tag; stored on a magnetic stripe or a memory chip as bit stream. Depending on the kind of product, its value and its production process the economically best solution can be chosen.

A further object of the invention is the field inspection of products at any place to determine the authenticity of products or to trace the way of distribution of products. A first proof of authenticity is carried out by decoding the enclosed unique product-inspection sequence of a product and tests its consistency. In a second step further comparisons with data stored on a computer system are carried out to recognize for example cases where a counterfeiter copied valid unique product-inspection sequences and affixed them to forged products.

For generating unique product-inspection sequences the same number of preceding sequences so called product-individual identification sequences is required. The product-individual identification sequence can be for example an already existing serial number of products or a generated random bit sequence assigned to each piece of product. The product-individual identification sequence or a subsequence derived from it is encoded by means of an encryption method using a secret encryption key, whereby a unique identification sequence is generated. The unique identification sequence or a combination of the unique identification sequence and the product-individual identification sequence or a subsequence of one of the said sequences is delivered with each piece of product as unique product-inspection sequence. The sequence or its complementary data need to be stored in log files in the system for subsequent examinations.

According to the present invention for encoding and decoding of unique product-inspection sequences any kind of symmetrical encryption method or asymmetrical encryption method can be used. For the encoding in addition to the encryption method a secret encryption key is required which need to be kept secret in a way that only legitimate parties are able to gain access to the secret key. Parties who can access the secret encryption key can generate product inspection sequences if the encryption method is known.

A variation of the present invention is using a symmetrical encryption method where a secret decryption key is necessary for verifying the consistency of unique product-inspection sequences. The decryption keys need to be kept secure in the same way as the encryption keys. The decryption keys need to be kept secure because it is possible to calculate the secret encryption key out of the decryption key. Without knowledge of the secret decryption key it is not possible to test the consistency of encoded unique product-inspection sequences.

A further variation of the present invention is using an asymmetrical encryption method where as well an encryption and decryption key is required. The encryption key need to be kept secret but the decryption key can be published since the encryption key cannot be computed from the public decryption key with current available standard computer capacity. An asymmetrical encryption method enables in particular a field examination, which can be executed for example by authorities, a wholesale dealer, a retailer or a consumer at any place.

Another object of the present invention in order to increase the security and to shorten long unique product-inspection sequences is to utilize additionally to the encoding so-called hash methods. A hash method can be utilized before, after or before and after the encryption is conducted. Beyond shortening unique product-inspection sequences the execution of additional hash methods increases the security of the encoded sequences.

Further objects of the present invention are log and registration files where in the log files all kind of transactions processed by the system are recorded in particular each proof of the authenticity of a unique product-inspection sequence is recorded. The registration files are used to store data about the parties who can carry out proofs of authenticity of unique product-inspection sequences. All the collected and stored data in the log files and registration files is used for comparison to determine a product as original or as falsification.

Further objects and advantages of the present invention will be apparent from study of the specification description, the claims and the attached drawings.

### BRIEF DESCRIPTION OF DRAWINGS

In the following the invention is further described with several drawings, which contain samples of possible implementations.

FIG. 1 is a block diagram showing an example of a computer system that represents a so-called product-protection system according the present invention as described later in details.

FIG. 2 shows a flowchart how to determine a product as original or falsification.

FIG. 3 is a schematic representation of the encryption of an alphanumerical sequence.

FIG. 4 is a schematic representation of the decryption and comparison of a subsequence, which is to consider as inverse execution of the encryption shown in FIG. 3.

FIG. 5 is a schematic representation of the decryption and comparison of a sequence, which is to consider as inverse execution of the encryption shown in FIG. 3.

FIG. 6 is a schematic representation of the encryption of a sequence, whereby before the encryption a hash method is applied.

FIG. 7 is a schematic representation of the decryption and comparison of a sequence, whereby after the decryption an inverse hash method is applied which is to consider as inverse execution of the encryption shown in FIG. 6.

FIG. 8 is a schematic representation of the decryption and verification of a sequence as a partially inverse processing of the encryption and a partially encryption as shown in FIG. 6.

FIG. 9 is a schematic representation of the encryption of a sequence, whereby after the encryption a hash method is applied.

FIG. 10 is a schematic representation of the decryption and comparison of a sequence, whereby before the decryption an inverse hash method is applied which is to consider as inverse execution of the encryption shown in FIG. 9.

FIG. 11 is a schematic representation of the partially decryption and comparison of a subsequence, whereby before the decryption an inverse hash method is applied which is to consider as inverse execution of the encryption shown in FIG. 9.

FIG. 12 shows a schematic representation of the encryption of a sequence, whereby before and after the coding a hash method is applied.

FIG. 13 shows a schematic representation of the decryption and comparison of a sequence, whereby before and after the coding an inverse hash method is applied, which is to consider as inverse execution of the encryption shown in FIG. 12.

FIG. 14 shows a schematic representation of a partially decryption, partially encryption and comparison of the sequences, whereby before the coding a hash method is applied which is to consider as inverse execution of the encryption shown in FIG. 12.

### DETAILED DESCRIPTION

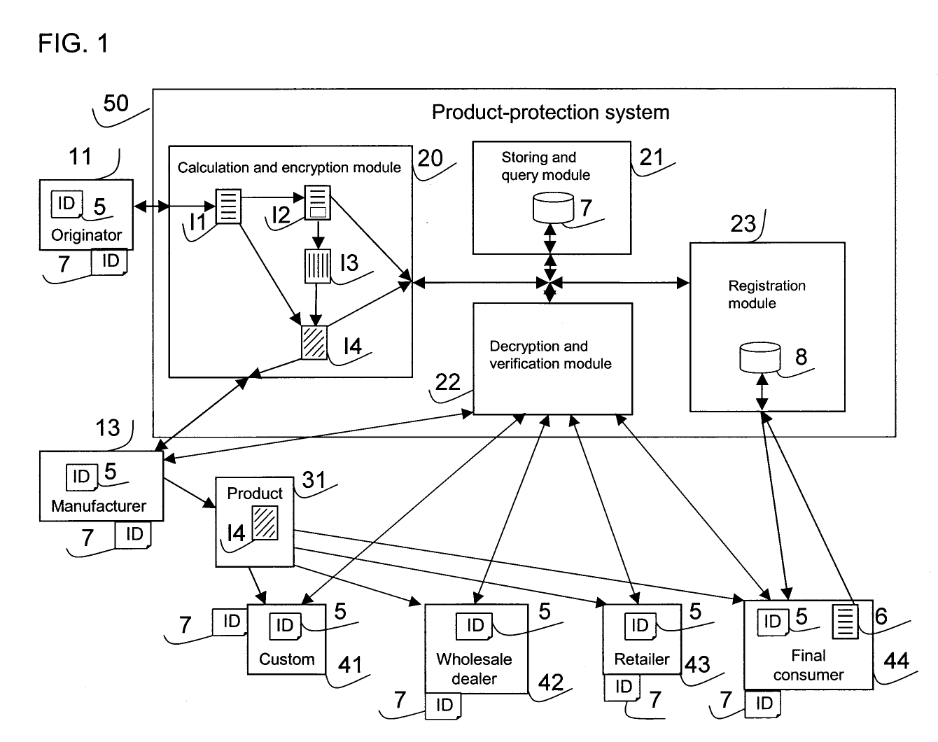

Referring now to the drawings and in particular to FIG. 1 there is shown a first block diagram of a first embodiment of the present invention. The example can be used for any kind of products. It is assumed that an originator 11 orders products by a manufacturer 13 whereby the originator 11 and the manufacturer 13 are different parties. The product 31 is then delivered to a wholesale dealer 42 into a different country where a custom 41 is involved. From the wholesale dealer 42 the product 31 is delivered via a retailer 43 to the final consumer. The final consumer according to this case is an individual who consume the product 31. Each of the said parties is registered and authorized to use the system, has a log-on ID 5 and is using a computer system with an ID 7.

The single modules as shown in FIG. 1 as there is a calculation and encryption module 20, a storing and query module 21, a decryption and verification module 22 and a registration module 23 together represent a so-called product-protection system 50. Each of the modules is setup to carry out special processes. The modules of the product-protection system 50 can be combined into a single software module or each of the modules operates as separate software module. For security reasons and performance it is of advantage if the modules operate on separate computer systems.

The carried out processes and transactions on each module are recorded and stored in so-called log files 7. The registration module 23 includes so-called registration files 8 where data for legitimization of the parties those access the product-protection system 50 is stored. It is of advantage if the log files 7 and registration files 8 are built up as structured files or as databases.

Furthermore it is of advantage in case the computers and input devices are connected via a public data line for example the Internet to use secure data transmission protocols for example secure socket layer (SSL) or Internet protocol security (IPSEC) and to use secured authentication systems for example Kerberos or Radius to legitimate and restrict the access to the product-protection system 50 and the software modules for the parties according their tasks.

The product-protection system 50 according to the present invention consists of computer hardware and computer software. The computer hardware can either be one single computer or a complex computer system based on several computers setup at different locations and different kind of input devices connected for example scanner or barcode reader which can be connected with each other by any kind of data connection for example dial up connections or the Internet depending on the requirements of the parties using the system.

The product-protection system 50 can be setup as a one client system where only one company is using the system for processing and storing data or it can be setup as multi client system where a unlimited number of companies at the same time can process and store data at the physically same system. In case of a multi client system the system need to be setup in a way that it is impossible that parties of one client can access the data of other clients except they are authorized for. This can be assured by setting up appropriate authorizations and assign them to the clients using the system.

Each of the modules of the product-protection system 50 can be setup as independent software module or all modules can be combined into one software module. The modules can be embedded in existing systems where the functionality according to this invention represents an extension of the said system. In particular the calculation and encryption module 20 can be embedded in software such as production planning and controlling tools. The decryption and verification module 22, the storing and query module 21 and the registration module 23 can be embedded in particular into existing business solutions, which are for example in use for trading or customer relationship management.

All the involved parties are very much interested in dealing only with original products. The custom 41 to avoid smuggling goods into foreign countries, the wholesale dealer 42, the retailer 43 and the final consumer 44 want to have assured that they acquired the original product. If the wholesale dealer or retailer sells falsified product copies the manufacturer may stops the supply via this way of distribution and the brand name may loose its good reputation. In general it can be assumed that copied products are of less quality than the original products, to that all involved parties carry a higher risk.

The product-protection system 50 according to the present invention is a system based on apparatus and methods of protecting products against counterfeiting in a simple and cost effective way. The requirements are to deliver a high secure encrypted sequence a so-called unique product-inspection sequence I4 with each piece of product in a way as explained later in the present invention, proof the consistency of this unique product-inspection sequence I4 via a computer system and carry out additional comparisons. Based on the result of a consistency test of those unique product-inspection sequence I4 and logical comparison of the said sequence with data stored on a product-protection system 50 products can be determined as original or falsification.

The unique product-inspection sequence I4 is calculated by processing a sequence, which is associated with each piece of product for example a serial number whereby, this sequence according to the present invention is called product-individual sequence I1. The product-individual sequence I1 is further processed to a so-called input sequence I2. Encoding and carrying out hash methods to a sequence called identification sequence I3 then further process the input sequence I2. Finally the identification sequence I3 is further processed to the unique product-inspection sequence I4.

In the following described example the product-protection system 50 is build up as a system based on four computers whereby on each computer different modules are operating. The computers are internally connected via local network connections. The external parties access the product-protection system via public lines by using SSL for secure data transmission.

The product-protection system 50 according to the present invention consists of the modules: Calculation and encryption module 20, Decryption and verification module 22, Storing and query module 21 and Registration module 23.

1) Calculation and encryption module 20 containing the: a) computer instruction set to generate product-individual sequences 1; b) computer instruction set to calculate input sequences 12; c) computer instruction set to calculate identification sequences 13 by encrypting input sequences 12; d) computer instruction set to carry out hash methods; e) computer instruction set to calculate unique product-inspection sequences 14 from identification sequences 13; f) computer instruction set to assure unique product-inspection sequences 14 within one product-protection system 50; g) computer instruction set to legitimize parties who would like to use this module and to assign the appropriate authorization; h) computer instruction set to verify the authorizations assigned to a party with the required authorization for each instruction set if the assigned authorizations are sufficient to execute the instructions of an instruction set; i) computer instruction set to record transactions which are carried out within this module into log files; j) computer instruction set to encrypt sequences stored in log files for subsequent comparison; k) computer instruction set to query data stored in log and registration files; l) computer instruction set to generate and send messages; m) computer instruction set to build up an interactive interface for legitimized parties to carry out transactions;.

n) computer instruction set to receive data from and send data to remote terminals and input devices; o) computer instruction set to exchange data and messages with other modules of the product-protection system; p) log files to store data; q) interface to execute external commands and exchange data and messages with external programs.

2) Decryption and verification module 22 containing: a) computer instruction set to decrypt and encrypt sequences; b) computer instruction set to process hash and inverse hash instructions; c) computer instruction set to verify the consistency of unique product-inspection sequences 14; d) computer instruction set to verify and process logical comparison of retrieved data during a proof of authenticity with stored data in log files; e) computer instruction set to generate and send system messages; f) computer instruction set to record transactions which are carried out within this module into log files; g) computer instruction set to query data stored in log and registration files; h) computer instruction set to legitimize parties who would like to use this module and to assign the appropriate authorization; i) computer instruction set to build up an interactive interface for legitimized parties to carry out transactions; j) computer instruction set to verify the authorizations assigned to a party with the required authorization for each instruction set if the assigned authorizations are sufficient to execute the instructions of an instruction set; k) computer instruction set to receive data from and send data to remote terminals and input devices; l) computer instruction set to exchange data and messages with the other modules of the product-protection system; m) log files to store data; n) interface to execute external commands and exchange data and messages with external programs.

3) Storing and query module 21 containing the: a) computer instruction set to store sequences and complementary data of the sequences; b) computer instruction set to verify the authorizations assigned to a party with the required authorization for each instruction set if the assigned authorizations are sufficient to execute the instructions of an instruction set; c) computer instruction set to record transactions which are carried out within this module into log files; d) computer instruction set to query data stored in log and registration files; e) computer instruction set to exchange data and messages with the other modules of the product-protection system; f) log files to store data; g) interface to execute external commands and exchange data and messages with external programs.

4) Registration module 23 containing the: a) computer instruction set to process the registration of parties before they can access the product-protection system 50; b) computer instruction set to legitimize parties to access the system;c) computer instruction set to assign authorizations to legitimized parties;d) computer instruction set to verify the authorizations assigned to a party with the required authorization for each instruction set if the assigned authorizations are sufficient to execute the instructions of an instruction set; e) public interface to process the registration of public parties and to publish data to the public; f) computer instruction set to store data of the registered parties; g) computer instruction set to verify the stored data of the registered parties with the data retrieved by legitimating parties; h) computer instruction set to record transactions which are carried out within this module into log files; i) computer instruction set to query data stored in log and registration files; j) computer instruction set to send messages and data to addresses about the registration of new parties; k) computer instruction set to receive data from and send data to remote terminals and input devices; l) computer instruction set to exchange data and messages with the other modules of the product-protection system; m) log files and registration files to store data; n) interface to execute external commands and exchange data and messages with external programs.

In a further extension of the present invention each of the parties who would like to access one of the modules of the product-protection system 50 according to the invention need to be successful legitimized before transactions can be carried out for example generating unique product-inspection sequences 14 or proof the authenticity of products 31. For security reasons the legitimization applies as well for automatic input devices. For a proper legitimization all of the involved parties as well as their automatic input devices such as magnetic card readers, bar code scanners or any other kind of input terminal are stored in registration files 8 with appropriate data. The registration files contain at least the log-on ID 5 and a password. It is of advantage when the input device ID 7 which can be for example an Internet Protocol (IP) address or a hardware address such as the Media Access Control (MAC) address of a network card, the full address of the enquirer, additional addressees with their preferred communication method to where system messages shall be send to are contained as well. In the explained sample all information's are stored in registration files 8.

In case an involved party for example a custom 41 would like to proof the authenticity of a product 31 he has to connect to the product-protection system 50 where it is required to input the log-in ID 5 and a password to gain access to the system. The login ID 5 and the password are in combination verified with the stored data in registration files 8 by the registration module. In case the login ID 5 and the provided password match the stored data in the registration file 8 the access to the system is granted. In addition to improve the security of the system the input device ID 7 is verified as well in this example. Further it is of advantage in case automatic input devices are used for the proof of authenticity to process the legitimization automatically. In addition legitimizations are recorded and stored in a log file 7. In case a legitimization fails the system administrator and other defined addresses get notified in real time by automatic generated system messages.

In accordance with a further favorable execution form of the invention a final consumer, who is basically not a registered enquirer, can check unique product-inspection sequences I4. Only after registration at the product-protection system 50 by using the public interface of the registration module 23 a final consumer can proof the authenticity of products.

The registration as final consumer 44 can be carried out in simple form by connecting to the public interface of the registration module via any kind of data connection for example the Internet, enter for example name, address, telephone number and email address. It is assumed that final consumers 44 who access the product-protection system 50 via the Internet do have an email address. The registration process requires filling in an application form 6 and transmitting this data to the registration module 23. The registration module 23 stores data and forward the access data as there is an ID 5 and an initial password to the email address provided during the registration process. Without the access data the final consumer 44 cannot log-on to the product-protection system 50 that however is required for the examination of unique product-inspection sequences 14.

In context with the registration of final consumers 44 the data entered during the registration process however cannot be considered as reliable. Further data, which can be retrieved during the registration process and during other usage of the product-protection system 50 from the data terminal of the final consumer 44 he connects to the product-protection system 50, can be manipulated as for example the IP address and thereby this data is not reliable. Only by considering these aspects this data of a final consumer 44 provided by registration should be used. A further variant is, when the data a final consumer 44 entered during the registration process is verified. If the data a final consumer 44 entered into the registration from 6 are confirmed without doubts, then this data can be seen as reliable and used for tests and further purposes like determining the way of distribution. For each case collecting and storing data of a final consumer 44 national legal regulations need to be considered.

The originator 11 who would like to have a product produced and brought to the market is very much interested to protect his product against counterfeits in a simple and cheap way. The originator 11 can either produce the product by its own company or the production can be outsourced to a location where the costs of the production are smaller as producing by its own or because the originator 11 does not have the production line as required for producing such a product. In all cases the originator 11 can use the system and method of the present invention:a) to secure the product against counterfeits and; b) to assure that the manufacturer 13 to where the production is outsourced produce exactly the number of pieces ordered by the originator 11.

In order to protect the products and to make sure that the manufacture 13 produce only the number of products the originator 11 wants to have produced the originator 11 need to provide the same number of unique product-inspection sequence I4 as much products he ordered from the manufacturer 13. In addition the originator need to make sure that the manufacturer 13 deliver with each product one unique product-inspection sequence I4.

For generating unique product-inspection sequences I4 the originator 11 need to connect to the product-protection system 50 and must be legitimized successful. After successful legitimating the originator 11 can access the calculation and encryption module 20, can calculate the encrypted identification sequence I3 and generate the unique product-inspection sequence I4. The originator can define the number how many sequences he wants to generate in one transaction with the calculation and encryption module 20.

Only authorized parties in particular the originator 11 are able to calculate identification sequences I3 and generate unique product-inspection sequences I4. Restricting the access to the secret encoding key K1 and assigning rights to generate unique product-inspection sequences I4 only to the originator 11 or a trusted party can assure this. For security reason it is of advantage when the secret encoding key K1 is not stored at any module of the product protection system.

For generating encrypted identification sequences I3 the originator 11 need to provide for each encrypted identification sequences I3 one complementary product-individual sequence I1. The product-individual sequence I1 can either be given by the originator 11 for example as already existing serial numbers or any kind of product ID's or they can be generated by using the calculation and encryption module 20. The product-individual sequence I1 can be a continuous or random numerical or alphanumerical sequence, a sequence of alphabetical characters or a bit sequence. The product-individual sequence I1 or a subsequence derived from it is the input sequence I2 which is processed further in the calculation and encryption module 20 by using an encryption method E1 and a secret encoding key K1 to calculate the encrypted identification sequence I3. Based on the encrypted identification sequence I3 the unique product-inspection sequence I4 is generated.

For the encoding of the identification sequence I3 all known symmetrical and asymmetrical encryption methods where a key for the encryption and decryption is required can be utilized.

As unique product-inspection sequence I4 the encrypted identification sequence I3 can be assigned, or it can be a sequence based on any kind of combination of the encrypted identification sequence I3 and the unencrypted product-individual sequence I1 or it can be subsequence derived from one of the said sequences.

During generating product-inspection sequences I4 the calculation and encryption module 20 assure that within one product-protection system 50 the product-inspection sequence I4 is unique. After a product-inspection sequence I4 is generated it is checked if the same product-inspection sequences I4 exists already in a log file 7. In case a product-inspection sequences I4 exists already a new product-inspection sequences I4 is generated.

This unique product-inspection sequence I4 can be a numerical, alphanumerical sequence or a bit sequence depending on how the unique product-inspection sequence I4 shall be delivered with the product.

In a further extension of the invention the originator 11 generates exactly the numbers of unique product-inspection sequences I4 as many pieces of products he want to have produced by the manufacturer 13. This form of the invention is useful to define and control by the originator 11 the number of products 31 a manufacturer 13 is allowed to produce.

In case a manufacturer 13 produces more pieces of products 31 than unique product-inspection sequences 14 where delivered by the originator 11 the manufacturer 13 can enclose: a) copies of already used up unique product-inspection sequences 4; b) invalid unique product-inspection sequences 4; c) deliver the surplus produced product pieces 31 without unique product-inspection sequences 4.

All kind of illegal produced product pieces 31 will be recognized by the product-protection system 50 during a proof of authenticity.

In one realization form of the invention the unique product-inspection sequences 14 can be delivered automatically or manually in electronic form to the manufacturer 13 even directly to the device which affix the unique product-inspection sequence I4 to the product. In a different realization form of the invention the manufacturer 13 accesses the calculation and encryption module 20 of the product-protection system 50 and after successful legitimization he can retrieve the unique product-inspection sequences 14. The retrieved unique product-inspection sequences 14 are then affixed to the product during the production process.

The unique product-inspection sequences I4 can be delivered with the product in many different ways. In accordance with a favorable execution form of the invention the unique product-inspection sequence I4 is printed or engraved in readable form on the product or its package as character string. It can also be printed on a label that is affixed to the product or its package. For example the unique product-inspection sequence I4 as well as the serial number is printed on the product whereby the unique product-inspection sequence I4 as alphanumeric character string and the serial number as number sequence with digits from 0 to 9.

The moreover it is of advantage, if the unique product-inspection sequence I4 is in machine-readable form. For example the unique product-inspection sequence I4 is carried out as 2D or 3D bar code or as machine-readable alphanumerical characters. The unique product-inspection sequence I4 could be applied as well on a magnetic stripe or on a memory chip, which is affixed to the product or implemented into the product. Since with this execution form of the invention the unique product-inspection sequence I4 can be recognized automatically by an input device to proof the authenticity, longer unique product-inspection sequences I4 can be used. The unique product-inspection sequence I4 can consist in this case of any bit sequence and is not limited to alphanumeric characters.

As a further favorable execution a radio frequency identification (RFID) tag containing the unique product-inspection sequence I4 as bit stream that is implemented into, affixed to the product or its package or delivered with the product as accompanying piece.

A further version of the execution is storing the unique product-inspection sequence I4 in addition to user data on a medium which data is not changeable for example on read-only memory chips (ROM), read-only compact disks (CD's) or digital versatile disks (DVD's) containing software, audio or video data.

A form of the execution can also be, if the unique product-inspection sequence I4 is in visually readable form printed on the product or its package. With this execution form of the invention the unique product-inspection sequence I4 can be entered into a data input device by an enquirer by typing in via a keyboard.

In accordance with a further favorable execution form of the invention the unique product-inspection sequence I4 is printed in readable form on an instruction leaflet as character string, machine-readable character string or as barcode which is delivered with the product or supplied separately. In this way a longer unique product-inspection sequence I4 can be generated where the product is not be impaired.

Depending on the kind of product, its value and its production process the economically best solution can be chosen to enclose the unique product-inspection sequence I4 with the product. The production of the component carrying the unique product-inspection sequence I4 can even be outsourced to third parties. Depending on the product it is of advantage to deliver the unique product-inspection sequence I4 in more then one form with the product 31 for example in readable form for manual input and in machine-readable form for automatic detection or scanning.

The manufacturer 13 produces on request by the originator 11 the products 31 and delivers them with the enclosed unique product-inspection sequence I4 into the market. In case the manufacturer 13 produces more products 31 as requested by the originator 11 the manufacturer 13 can enclose already used up unique product-inspection sequences I4, invalid unique product-inspection sequences I4 or deliver the surplus produced products 31 without unique product-inspection sequences 14. All kind of illegal products 31 will be recognized by the product-protection system 50 according to the present invention during a proof of authenticity.

In a further extension of the present invention the transactions carried out by the originator 11 and the manufacturer 13 with the modules of the product-protection system 50 are all recorded and stored in log files 7 by the storing and query module 21. The generated unique product-inspection sequences I4 and all required complementary data of the unique product-inspection sequences I4 is stored as well in the log file 7 by the storing and query module 21.

In a further execution of the invention it is of advantage when the manufacturer 13 is obliged to report the products 31 and the unique product-inspection sequences I4 he delivered to the market with delivery point of time and receiver of the products 31 either to the originator 11 or to the product-protection system 50 where the information is stored in log files 7 in the storing and query module 21. In case the manufacturer 13 reports to the originator 11 it is of advantage when the originator forwards this information to the product-protection system 50 where it is then stored in log files 7 by the storing and query module 21 for subsequent queries.

The product 31 with the associated unique product-inspection sequence I4 is delivered from the manufacturer 13 into the market. The first party who gets in contact with the product 31 in case of this example is the custom. After the product 31 passed the custom it is usually distributed via a wholesale dealer 42 and a retailer 43 to the final consumer 44. The custom 41, the wholesale dealer 42 and the retailer 43 have a special interest in the authenticity of the product. The custom would like to proof if the product 31 match the declared product in the waybill. The wholesale dealer 42, the retailer 43 and the final consumer 44 want to assure that they acquired an original product and not a counterfeit.

According to the example of the present invention the custom is involved in the chain of verifying the authenticity of products. It is assumed that the custom 41 is registered already at the registration module 23. Before proofing the authenticity of a product the custom 41 need to connect to the product-protection system 50 and legitimized first to carry out a proof of authenticity of a product 31. After the custom 41 connects to the product-protection system 50 the log-on ID 5 and a password must be entered. In addition the device ID 7 is verified if it matches the stored combination of log-on ID 5, password and device ID 7. When the custom is successful legitimized the unique product-inspection sequence I4 can be entered and transmitted to the decryption and verification module 22 for examination.

The decryption and verification module 22 decrypt the received unique product-inspection sequence I4 by means of the decoding procedure D1 using the decryption key K2 and calculate a test sequence T1. The test sequence T1 is compared with the complementary data of the unique product-inspection sequence I4 that is stored in the log files 7 in the storing and query module 21. The result of the verification is reported to the enquirer as well as to other defined addressees. In case the unique product-inspection sequence I4 was transmitted by an automatic input device the result of the verification is only send to the addressees assigned to this device.

After the product 31 with the associated unique product-inspection sequence I4 was successful approved and passed the custom 41 the product 31 is usually distributed via a wholesale dealer 42 and a retailer 43 to the final consumer 44.

By means of the present invention each authorized party can carry out proofs of authenticity of products 31 by verifying the consistency of encoded unique product-inspection sequence I4 delivered with each piece of products 31.

Before the verification of a unique product-inspection sequence I4 can be processed a feasible test sequence need to be calculated out of the unique product-inspection sequence I4 by carrying out the decryption and further calculations.

If a symmetric encryption method was used for the encoding of the unique product-inspection sequence I4 the decryption must be carried out in an inverse calculation by using the secret decryption key K2 and the decryption method D1. With symmetrical encryption method it is necessary to keep both the encryption key Kᵢ and the decryption key K2 secret. Since the coding can be accomplished within modules where a legitimization is required and the access to data and transaction is controlled by authorizations, the secrecy of the decryption keys can be ensured in a centralized as well as in decentralized built product-protection system 50.

In an execution form of the present invention the unique product-inspection sequence I4 is only calculated by encoding the product-individual sequence I1 or a subsequence derived from it. In such cases the decoding of the unique product-inspection sequence I4 is carried out by means of the decryption method D1 with the encryption key K2 in order to calculate a test sequence T1. The in such a way calculated test sequence T1 can be examined by verifying whether it matches the data or the complementary data, which is stored in log files 7 and assigned to the unique product-inspection sequence I4.

In an alternative version of the present invention the unique product-inspection sequence I4 consists of a combination of the unencrypted input sequence I2 and the encoded unique product-inspection sequence I4. The test sequence T1 is retrieved by decoding the unique product-inspection sequence I4 and the test sequence T1 is compared with the unencrypted input sequence 2. If the test sequence T1 matches the input sequence 2, which was used as input sequence for the calculation of the encoded unique product-inspection sequence I4, then the examined unique product-inspection sequence I4 is consistent. The first comparison with the stored data in the log file 7 in the storing and query module 21 reports then the result, that the unique product-inspection sequence I4 is authentic. If the test sequence T1 does not match the input sequence 2, then the unique product-inspection sequence I4 is incorrect. If other errors can be excluded, the checked product 31 is identified as a falsification.

If for encoding of unique product-inspection sequence I4 asymmetrical encryption methods E1 are utilized the decoding can be carried out with a public decryption key K2, a so-called “Public key”. In case of using asymmetrical methods the decryption key K2 does not have to be kept secret. This is important for further extensions of the present invention where a decentralized proof of authenticity is carried out. The decryption key K2 could then be stored as public key on decentralized testing devices, which can be used in particular for field inspections. In addition or instead of storing the decryption key K2 on decentralized testing devices the decryption key K2 can even be published via the public interface of the product-protection system 50.

In case of carrying out decentralized proofs of authenticity decentralized testing devices need to contain a computer system where: a) the unique product-inspection sequence I4 can be input manually or automatically depending on the way how the said sequence is delivered with the product; b) one or many public decryption keys k2 can be stored and easily added or removed; c) computer instructions can be stored and executed which utilizes the decryption, comparison and reports the result; d) the decrypted sequence can be compared with the product-individual sequence I1 or the input sequence I2 depending on the sequence delivered with the product; e) the unique product-inspection sequence I4 and its test result as well as useful data like data and time of the test can be stored; f) data can be exchanged with a central computer system or even the product-protection system 50 to transfer the stored data from the decentralized testing device to the product-protection system 50 for further comparison and storing.

_Ref67055728In a version of the present invention a product-individual sequence I1 and a unique product-inspection sequence I4 are both enclosed with a product 31. A public key K2 is stored on a decentralized testing device where the consistency test of unique product-inspection sequences I4 can be examined. By doing so the unique product-inspection sequence I4 is input into a decentralized testing device where the said sequence is decoded with a decryption method D1 by using the public key K2. The in such a way calculated test sequence T1 can then be compared with the product-individual sequence I1. In case the product-individual sequence I1 and the test sequence T1 matches then this result is the reference that the unique product-inspection sequence 4 is authentic.

In case of field inspections with off-line testing devices it is of at advantage when the information, which unique product-inspection sequence I4 was tested, its appropriate data as there is the test result, date and time when the test was conducted and the ID 7 of the testing device are stored on the decentralized testing device. When the unique product-inspection sequences 14 of all products 31 are tested the decentralized testing device is later connected via any kind of data line to the product-protection system 50 or to a different computer to where the stored data is transmitted. In case the data is first transferred to a different computer system. When the data is finally transmitted to the product-protection system 50 further comparisons are carried out to determine the tested products as original or as falsification. The product-protection system 50 carries out these comparisons automatically and reports the result to addressed parties in real time. The information to which party and in which way the result shall be reported is stored in registration files 8 associated with the log-on ID 5 and the device ID 7.

_Ref67055728However there are product falsifications conceivable, where a counterfeiter could obtain one or many unique product-inspection sequences 14 for example by copying them from original products or in a different way and enclose them with falsified products or a manufacturer 13 produce more products as ordered by an originator 11. The falsified products then contain valid unique product-inspection sequences I4 and by the first proof of authenticity by testing the consistency of the unique product-inspection sequence I4 these products are not recognized as falsifications. In order to identify product falsifications with valid unique product-inspection sequences I4, further comparisons must be carried out.

A first additional test is to check whether an enquirer tested the unique product-inspection sequence I4 already in former times. Such cases of multiple tests are identified in a second comparison with queries processed on log files 7 where the unique product-inspection sequence I4 is the search criteria for the query. In the log files 7 for each former carried out proofs of authenticity of unique product-inspection sequences I4 an appropriate record is created. For proper identification such a said entry contains at least one of the following sequences: the unique product-inspection sequence I4 and the product-individual sequence I1. Beyond that it is of advantage when the entry contains at least the identification ID 5 of the enquirer, who carried out the proof of authenticity, the ID 7 of the input terminal from which the proof of authenticity was carried out, date and time when the proof of authenticity was carried out as well as the result of the proof of authenticity. Since the system is intended for a worldwide use, it is of advantage to store date and time in an international comparable format.

With each proof of authenticity of products 31 queries of the data stored in log files 7 are carried out. In case of previous off-line tests of the unique product-inspection sequence I4 this query is carried out as soon as the data is transmitted from the off-line device to the product-protection system 50 and confirmed as completed.

After the query and in case no former proof of authentication of the unique product-inspection sequence I4 is detected there are three possibilities: a) it is an original product; b) it is a falsification with a valid unique product-inspection sequence I4 where the original product is not checked so far; c) an input error or an error during transmission occurred which by coincidence represents a valid unique product-inspection sequence I4.

In case former proofs of authentication of the unique product-inspection sequence I4 are detected there are five possibilities: a) it is an original product whose unique product-inspection sequence I4 is checked again now by another enquirer than before; b) it is an original product, whose unique product-inspection sequence I4 is checked again by the same enquirer than before; c) it is an original product and the former checked product of this particular unique product-inspection sequence I4 was a falsification; d) it is a falsification where the valid unique product-inspection sequence I4 was copied from an original product and enclosed with the falsification and the previous checked unique product-inspection sequence I4 is the original; e) an input error or an error during transmission occurred which by coincidence represents a valid unique product-inspection sequence I4.

By comparing data stored in log files 7 associated with the unique product-inspection sequence I4, data stored related to the enquirer in registration files 8 as well as data stored about input devices with data retrieved from the enquirer and from the input device as there is for example the input device ID 7 now further conclusions can be considered to identify if a product whose unique product-inspection sequence I4 is checked is an original or a falsification.

The probability of an incorrect input or of an error during transmission, which by coincidence represents a valid unique product-inspection sequence I4, is rather very small by the use of the coding technology and the hash methods according to the present invention. The probability of an incorrect input or an error during transmission can be excluded with very high probability by carrying out additional logical comparisons in conjunction with the log files 7.

In a variant of the present invention where the recorded information is stored in log files 7 and in registration files 8 the way of distribution of products 31 can be verified as additional test to proof the authenticity of products 31. If an enquirer carries out the examination of unique product-inspection sequences I4 the device ID 7 of the input terminal is transmitted to the product-protection system 50. By using the device ID 7 in combination with the ID 5 of the enquirer the current location of the product can be determined by querying the log files 7 and registration files 8. Comparing the in such a way determined current location with the way of distribution stored in log files 7 can be used to determine a product as original or as falsification. The way of distribution was previously either entered by an originator 11 or a manufacturer 13. It is for example very implausible if a final consumer 44 or retailer 43 in the USA can have acquired an original product that according to the records in the log files 7 was delivered to a wholesale dealer 42 in France particularly since a wholesale dealer 42 and a retailer 43 in France already examined the unique product-inspection sequence I4 of this product.

In a further version a test can be utilized if the ID 5 of the enquirer in coherence to the ID 7 of the input device match the data stored in registration files 8 and log files 7. The result of this test can be used to check whether the logged-on enquirer is using a correct registered input terminal or input device. In case of discrepancy it might be possible that an unauthorized party gained access with a valid ID 5 and further actions should be taken into account for example to get in contact with the enquirer and confirm whether it is an authorized access or not and send system messages to responsible parties.

A product 31 usually follows a well-known way of distribution from the manufacturer 13 to the final consumer 44. In coherence to this described sample according FIG. 1 a custom 41, a wholesale dealer 42 and a retailer 43 get in contact with the product and each of them is very interested to carry out the examination of the unique product-inspection sequences 14 to proof the authenticity of a product 31. From the retailer 43 the product 31 is then delivered to the final consumer 44 who is after a simple registration at the product-protection system 50 able to carry out as well the proof of authenticity of the product he purchased. It can be assumed or even requested by the originator 11 or the manufacturer 13 that the proof of authenticity must be carried out by wholesale dealer 42 and retailer 43 however this cannot be assumed and requested from a final consumer. Wholesale dealer 42 and retailer 43 for example can carry out the test when products 31 are delivered on stock or sold out of stock.

A further example of implausibility is when a retailer 43 examines unique product-inspection sequences 14 which had up to then not examined by a wholesale dealer 42, although the unique product-inspection sequences 14 of such products 31 was in former cases always examined by a wholesale dealer 42 at first. The same applies in case a final consumer 44 in Europe examines a unique product-inspection sequence I4 that was at the same day reported by manufacturer 13 as delivered to USA.

The variants of logical comparisons of data retrieved with the unique product-inspection sequence I4 when an enquirer carries out a proof of authenticity in coherence with the data stored in log files 7 or registration files 8 are numerous and can be individually adapted according the requirements. In context of the examination one ore many logical comparisons can be carried out.

It is of advantage that as much as possible meaningful data is stored in logs files 7 or registration files 8 that can be used for further comparisons to identify if products 31 are original or falsification. The more data the files contains, the more reliable the result of the comparisons is.

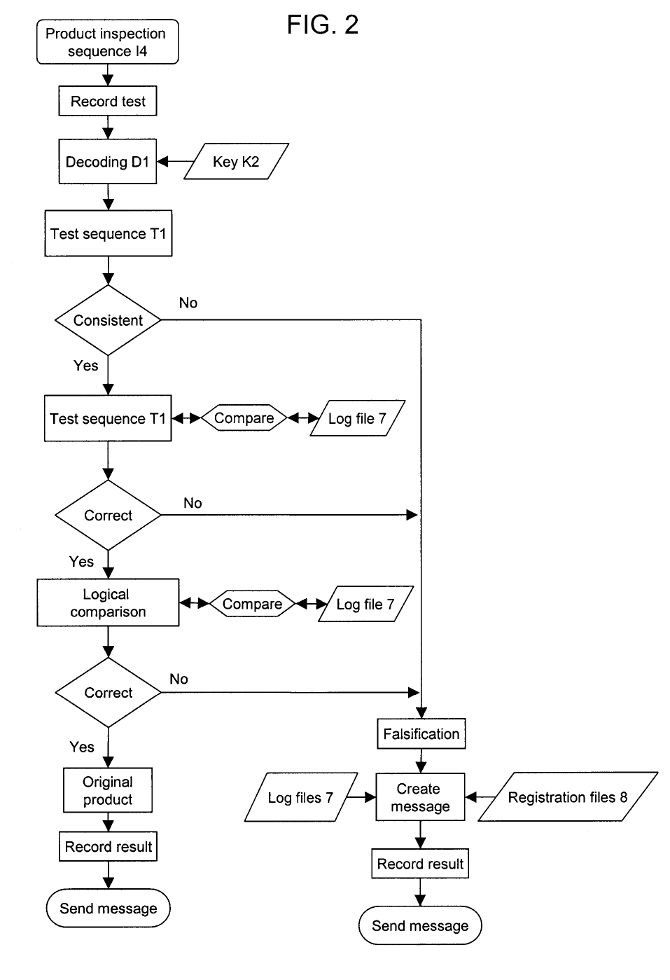

FIG. 2 shows a flow chart about the carried out tests and comparisons as explained by samples and how the conclusion is made if the examined unique product-inspection sequences I4 belongs to an original product or a falsification.

As shown in FIG. 2 after a unique product-inspection sequence I4 is received all the carried out actions are recorded. At first the unique product-inspection sequence I4 is decoded by means of a decoding method D1 by using a decryption key K2. After the decryption a test sequence T1 is received which is then proved of consistency. In case the test results in an inconsistency the product is identified as falsification. In case the result is consistent in a next test it is verified if the decoded test sequence T1 matches the data or the complementary data, which is stored in log files 7 and assigned to the unique product-inspection sequence I4. In case it does not match the system identify the product as well as falsification. When the data matches one or many logical tests are carried out afterwards.

A deviation at one of the logical tests permits the conclusion the product 31 might be a falsification. In this case the product-protection system 50 recognize a falsification, retrieves appropriate data from the log files 7 and registration files 8, generate a system message about the result, record this information in log files 7 and send a message to all the addresses defined in the registration files 8.

When all logical comparisons with the data of the log files 7 and registration files 8 where successful the addresses as defined in the registration files 8 get the confirmation that the product 31 is identified as an original. However it is still not for sure, because it could be possible that a counterfeiter used a copy of a valid unique product-inspection sequence I4 which so far was not examined and all the logical comparisons result in no irregularity. In this case the system would notice a falsification only if the unique product-inspection sequence I4 of the original product is examined later on.

A further favorable extension of the present invention is sending messages in real time not only to the enquirer but also to defined addresses in any case when examinations of unique product-inspection sequences 14 are carried out. Under certain circumstances the product-protection system 50 might send a success message to the enquirer but a warning message about the recognition of falsifications to one or many defined addressees. An addressee can be for example the originator 11, the manufacturer 13, official authorities or any other third party who is appointed to monitor the activities and need to be informed about. In case the examination is carried out automatically the message can only be addressed to defined addresses those are linked to an automatic input device. It is of advantage when the message contains information's about the product 31, current location of the device from where the examination is carried out, identity of the enquirer who carries out the examination and the present date and time. The message can be transmitted in different ways and forms depending on the favorable communication method setup for the addressee for example as a call from an automatic telephone system, by fax, by email or as a short message to wireless devices.

For calculating, decoding and encoding unique product-inspection sequences I4 it is of advantage to use standard and approved methods to assure high-secured sequences. Symmetrical and asymmetrical methods can be utilized whereby for each kind various algorithms exist. Not all the standard algorithms on the market are able to calculate secure unique product-inspection sequences I4. Depending on the method and the algorithm more or less resources for coding are required.

In case the product-protection system 50 is setup for more then one client the method and algorithm can be customized for each client it can even be changed during the run time of the system to improve the security. In case a variant of the present invention is setup to change the methods and techniques during the run time each unique product-inspection sequences I4 is linked to the method and algorithm which was used for coding and calculation whereby the information is stored in log files 7.

In a variant of the invention symmetrical encoding methods also called single-key or secret-key methods are utilized for the encryption and decryption whereby for both cases a secret key is used. For encoding an input sequence I2 a symmetrical encryption method E1 and a secret key K1 are used. The in such a way calculated unique product-inspection sequence I4 can only be decoded with knowledge of the secret key K2 and by using the equivalent symmetrical encryption method. A further substantial characteristic of symmetrical coding methods is that the encoded unique product-inspection sequence I4 cannot correct decoded without the secret key K2 even if the symmetrical encoding method is known. The secret key K1 of a symmetrical encryption method cannot be derived from different samples from pairs of encoded or decoded information's by current computing power.

When using symmetrical methods it must be assured that the encryption keys K1 and the decryption keys K2 are kept secret. Counterfeiters, who gain access to the secret keys, could produce authentic unique product-inspection sequences. In particular it is of advantage, if the used symmetrical encryption method is one of Blowfish, CAST-128, f8, IDEA, Rijndael, RC5 or Triple-DES algorithm.

Symmetrical encryption methods in general are very fast and can be implemented at little expenditure in hardware and in software. A further advantage of the use of symmetrical encrypting methods is the key and the block lengths are relatively short. Thus also the unique product-inspection sequence I4 can be short and can be enclosed comfortably with the product. Since the encoding and decoding by using symmetrical encryption methods can only be utilized by authorized parties where the access to all modules of the product-protection system 50 is secured by authorizations, the secrecy of the secret keys can be guaranteed by suitable measures, for example by the obligatory legitimating of the involved parties against the product-protection system 50 using the actual technical possibilities for secured data transmission.

Alternative to symmetrical encoding methods asymmetrical encoding methods can be used. With asymmetrical a method a pair of keys is used a secret key so-called private key for encoding and a non-secret key so-called public key for decoding. A private key K1 for the encryption need to keep secure and only accessible by authorized parties such as an originator 11. For security reasons the private key can even be stored outside of the product-protection system 50.

Since the private key of an asymmetrical encryption method can be derived neither from the decryption method D1, nor from the public decryption key K2 with today available computing power, the public key can be made freely available to all parties without any risk. It is not possible for a counterfeiter to generate valid unique product-inspection sequences I4 by using the public decryption key K2 even he has knowledge about the used encryption method E1.

The public key can either be distributed to enquirers or the public key can be published via the public interface of the registration module 23. This enables in particular a field examination, which can be executed by the custom 41, a wholesale dealer 42 or a retailer 43 at any location. It is of advantage if the asymmetrical encoding method is one of DSA, ECC or RSA algorithm.

In order to avoid that using always the same keys carrying out all coding it is of advantage to exchange the keys frequently to improve the security. In that case so-called key management should be established for the administration of the keys. For example different secret keys in temporal succession can be used in such a way that the validity of each individual key is temporary limited.

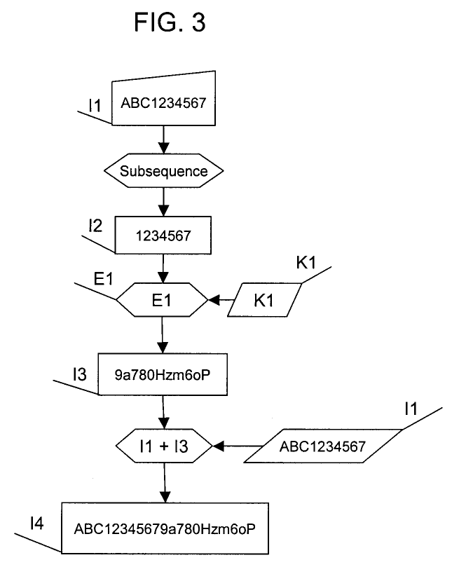

In the following the drawings FIG. 3 to FIG. 12 are explained by samples whereby for each sample symmetric encryption methods as well as asymmetric encryption methods are applicable. In case hash methods are utilized different hash techniques are applicable. The explained samples represent different ways of testing the consistency of unique product-inspection sequences 14 whereby not all possible options are explained by a sample.

In FIG. 3 the flow chart shows a sample where an alphanumerical serial number is used as product-individual sequence I1. An originator 11 or any other authorized party generates an input sequence I2 that represents a subsequence of the product-individual sequence I1 equivalent to the serial number. The input sequence I2 is then encrypted with the help of the encryption method E1 by using the secret encryption key K1, whereby as result an encoded identification sequence I3 is calculated. The unique product-inspection sequence I4, which is finally delivered with each piece of product, is calculated as a product of the product-individual sequence I1 and the identification sequence I3. Such a kind of unique product-inspection sequence I4 for example can as readable alphanumerical sequence or barcode printed on packages or instruction leaflets or engraved on a product such as sheet of glasses or metal.

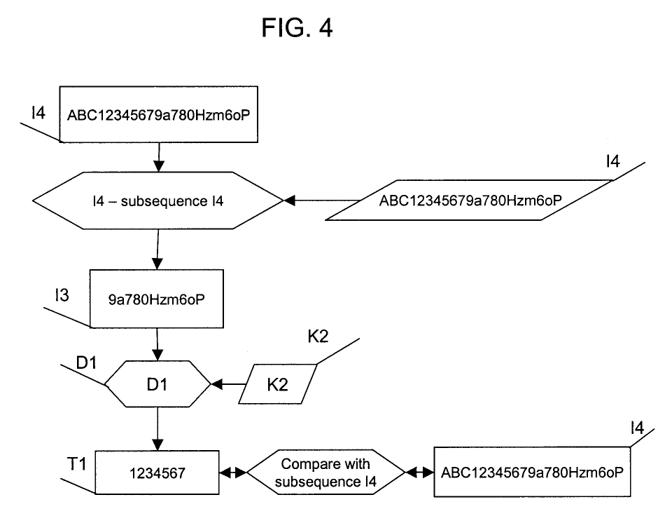

FIG. 4 shows an example of the decryption and comparison of a sequence, which is to consider as inverse execution of the encryption shown in FIG. 3 whereby a subsequence is used to check the consistency of unique product-inspection sequence I4. The decoding of the unique product-inspection sequence I4 is carried out as an inverse calculation process of the encoding shown in FIG. 3. At first the identification sequence I3 is calculated by subtracting a subsequence of the unique product-inspection sequence I4 from the unique product-inspection sequence I4. With help of the decryption method D1 by using a decryption key K2 the test sequence T1 is calculated whereby the decryption method D1 must be the same method as used to encrypt the unique product-inspection sequence I4. The consistency of the unique product-inspection sequence I4 is checked by verifying if the test sequence T1 is a subsequence of the unique product-inspection sequence I4 which is retrieved from a log file where it was stored previously.

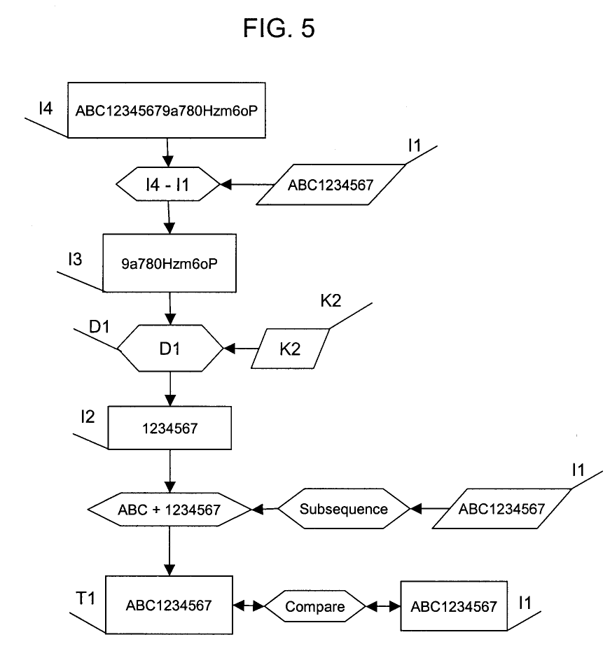

FIG. 5 shows an example where the consistency test of a unique product-inspection sequence I4 is carried out by verifying the complete test sequence T1 with complementary data as well as using stored data for the decoding. The decoding of the unique product-inspection sequence I4 is carried as an inverse calculation process of the encoding as shown in FIG. 3. At first the identification sequence I3 is calculated by subtracting the product-individual sequence I1 from the unique product-inspection sequence I4 whereby the product-individual sequence I1 is retrieved from a log file. With help of the decryption method D1 by using a decryption key K2 the input sequence I2 is calculated. Then a subsequence calculated from the product-individual sequence I1 is added to the input sequence I2 where after the test sequence T1 is calculated. The consistency of the unique product-inspection sequence I4 is checked by verifying if the test sequence is equal to the product-individual sequence I1 which is retrieved from a log file where it was stored previously. Consistency tests by verifying if the test sequence T1 is a subsequence of the unique product-inspection sequence I4 are possible because the unique product-inspection sequence I4 consists of the encoded identification sequence I3 as well as the product-individual sequence I1. By using this kind of method the consistency test can be carried out as off-line field inspection by using decentralized testing devices. The coding of the unique product-inspection sequence I4 as shown in FIG. 3, FIG. 4 and FIG. 5 is applicable for symmetrical as well as asymmetrical encoding methods. Because the decryption key K2 of symmetrical encryption methods needs to kept secret it is of advantage to use only asymmetrical encryption methods in case off-line field inspections shall be carried out. The public decryption key K2 can be stored on the decentralized testing device and the complete test of consistency can be carried out off-line.

By carrying out off-line examinations all tested unique product-inspection sequence I4 and complementary data is stored on the off-line testing device. Only the consistency of the unique product-inspection sequence I4 is not a final indication if the checked product is an original or a falsification.

After all off-line test are carried out the data stored on the off-line testing device should be transmitted at the earliest possible stage to the product-protection system 50 to carry out further comparison to determine if the products are originals or falsifications. The off-line testing device need to connect to the product-protection system 50 either directly via any kind of data line for example a wireless connection or the data from the off-line testing device can be transferred to a computer device which has a data connection to the product-protection system 50. After manually or automatically successful legitimization the data is transferred from the source where it is stored to the decryption and verification module 22 where further testing is carried out as soon as the data is transmitted.

In order to increase the security and to avoid long unique product-inspection sequences I4 it is of advantage to utilize in addition to the encoding so-called hash methods. A hash method can be utilized before the encryption of an input sequence I2 is conducted, after the encryption was performed. In particular it is of advantage, if a hash method is utilized before the encryption of the product-individual sequence I3 and a second hash method is utilized after the encryption. Beyond a short identification sequence I3 the execution of two hash methods increases the security of unique product-inspection sequences I4 in a way that for a counterfeiter it is nearly impossible to determine on basis of the unique product-inspection sequence I4 the underlying hash methods, the encryption method E1 as well as the underlying secret encryption key K1. In particular it is of advantage when the first and the second hash method is one of the MD 5, SHA-1, RIPE MD 160, MDC-2 algorithm. The carried out hash methods before and after the encoding can be of different algorithms.

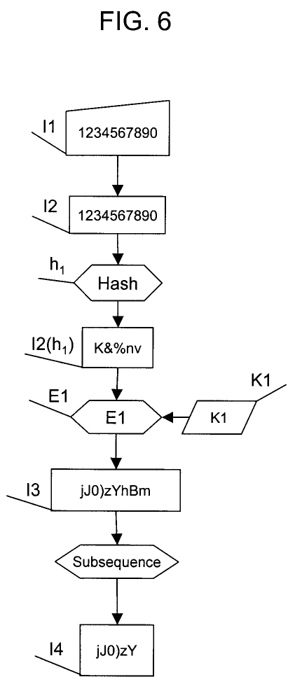

FIG. 6 shows a sample where before the encryption a hash method h₁ is carried out. It is assumed that the product-individual sequence I1 is a 10-digit number. The input sequence I2 is equal to the product-individual sequence I1 by meaning no processing in this step is necessary. The input sequence I2 is then further processed by utilizing a hash method h₁ whereby the hashed sequence I2(h₁) is calculated. This hashed sequence I2(h₁) is then encrypted by means of the encryption method E1 by using the secret encryption key K1 to receive the encoded unique product-inspection sequence I3. The unique product-inspection sequence I4 that is delivered with the product is then calculated as subsequence of the identification sequence I3. The complementary data of the subsequence is stored in log files 7 in the product-protection system 50 in correlation to the unique product-inspection sequence I4.

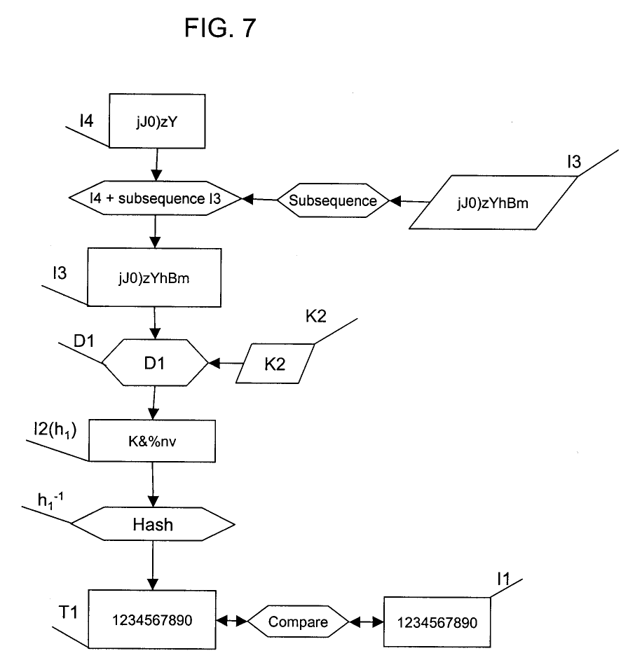

FIG. 7 shows the decryption and verification of the unique product-inspection sequence I4 as inverse processing of the encryption shown in FIG. 6. At first the calculation of the identification sequence I3 that is a product of the unique product-inspection sequence I4 and the complementary data of the subsequence of the identification sequence I3. The appropriate subsequence can be retrieved from a log file 7 whereby the unique product-inspection sequence I4 is the criteria to select the correct subsequence. The identification sequence I3 is further decoded with the help of a decryption method D1 by using a decryption key K2 whereby the hashed identification sequence I2(h₁) is received. In a next step the inverse function of the hash method h₁ meaning h₁⁻¹ is carried out whereby the test sequence T1 is received. In a next step the calculated test sequence T1 and the product-individual sequence I1 are compared.

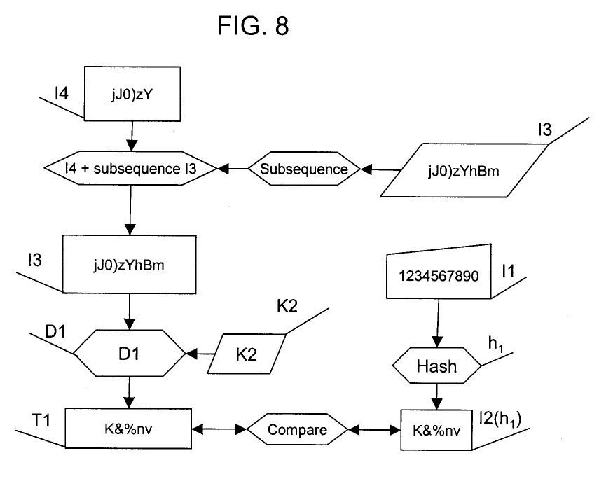

FIG. 8 shows a sample of a consistency test of a unique product-inspection sequence I4 as a partially decryption and a partially encryption. At first the identification sequence I3 is calculated as a product of the unique product-inspection sequence I4 and the complementary data of a subsequence of the identification sequence I3. The appropriate subsequence can calculated from an identification sequence I3 stored as complementary data to the said unique product-inspection sequence I4 in a log file 7. The identification sequence I3 is then further decoded with help of a decryption method D1 by using a decryption key K2 where after the test sequence T1 is received. In a second step the complementary product-individual sequence I1 of the unique product-inspection sequence I4 that is stored in a log file 7 is processed to a hashed identification sequence I2(h₁) by using a hash method h₁. The validity of the unique product-inspection sequence I4 is now compared by verifying the test sequence T1 with the hashed identification sequence I2(h₁).

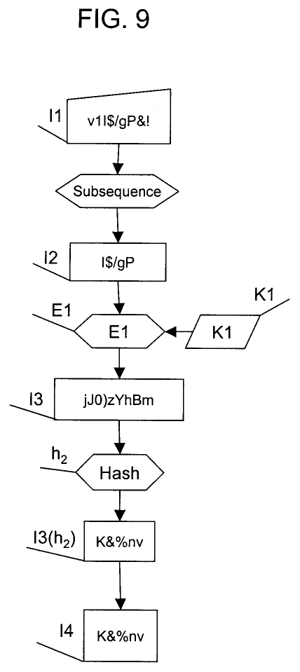

FIG. 9 shows a flow chart where after the encryption a hash method h₂ is carried out. An originator 11 or an authorized party generates a random product-individual sequence I1 where after a subsequence represents the input sequence I2. The input sequence I2 is then encrypted with an encryption method E1 by using a secret encryption key K1 where as result the identification sequence I3 is retrieved. In a next step the identification sequence I3 is further processed by means of a hash method h₂ into a hashed identification sequence I3(h₂). The hashed identification sequence I3(h₂) is then without further processing used as unique product-inspection sequence I4.

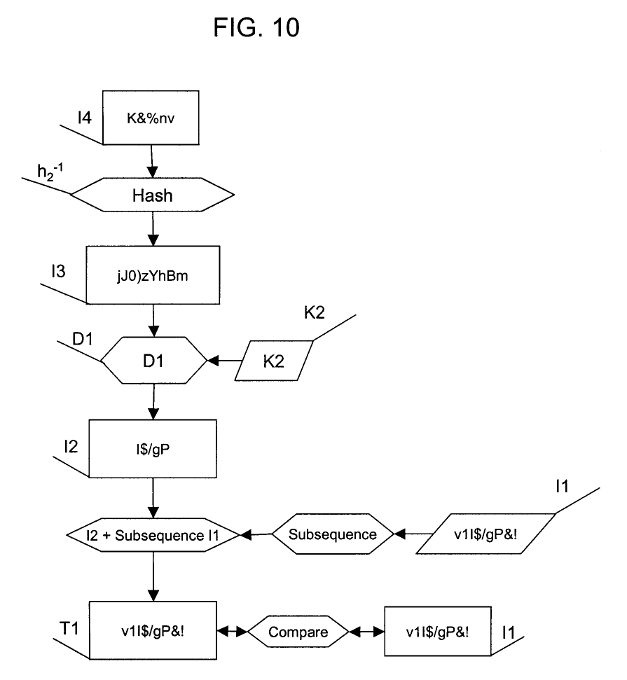

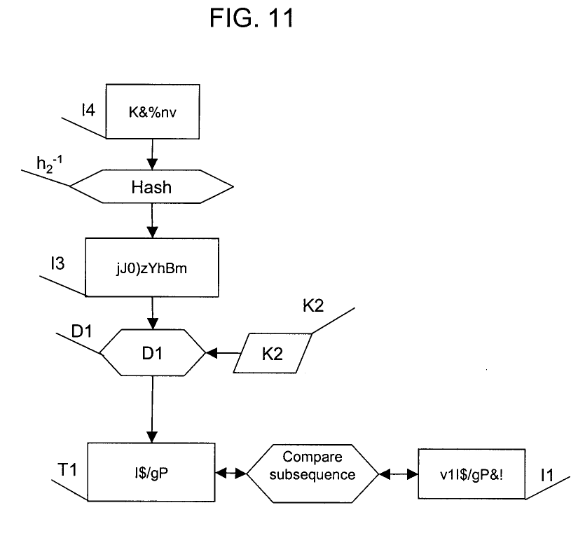

The verification of the consistency of the unique product-inspection sequence I4 according to the explained sample of FIG. 9 can be carried out in two different ways as explained later in FIG. 10 and FIG. 11.

In FIG. 10 a first way of consistency test of a unique product-inspection sequence I4 is explained which was encrypted as shown in FIG. 9. At first a hash inverse function h₂⁻¹ is carried out for the unique product-inspection sequence I4 whereby the encoded identification sequence I3 is retrieved. The unique identification sequence I3 is further decoded with the help of a decryption method D1 by using a decryption key K2 whereby the input sequence I2 is received. Based on the inverse execution of the same formula for the calculation of the subsequence used during the encryption process the test sequence T1 can be calculated as product of the Input sequence I2 and the subsequence of the product-individual sequence I1. The consistency of the unique product-inspection sequence I4 can be checked by verifying if the test sequence T1 is equal to the product-individual sequence I1 that is stored in a log file 7 as complementary data to the unique product-inspection sequence I4.

In FIG. 11 a second way of consistency test of a unique product-inspection sequence I4 is explained which is encrypted as shown in FIG. 9. At first a hash inverse function h₂⁻¹ is carried out for the unique product-inspection sequence I4 whereby the encoded identification sequence I3 is retrieved. The unique identification sequence I3 is further decoded with the help of a decryption method D1 by using a decryption key K2 whereby the test sequence T1 is received. The consistency of a unique product-inspection sequence I4 in this case can be checked by verifying if the test sequence T1 is a subsequence of the product-individual sequence I1.

By applying a hash method h₂ after the encoding it is in particular possible to avoid long identification sequences I3 before they are processed further to unique product-inspection sequences I4. In particular when using asymmetrical encoding procedures, which generate large key lengths and large block length a hash method after the encoding seems more appropriate.

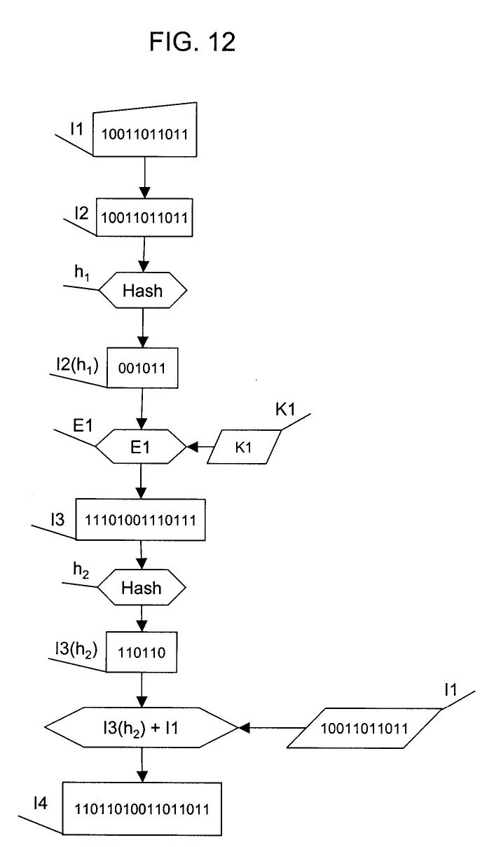

The flow chart in FIG. 12 shows a sample where a hash method is carried out before and after the encryption. In this example it is assumed that an originator 11 or an authorized party generates random product-individual sequence I1 as bit sequences by using the calculation and encryption module 20 of the product-protection system 50. The storing and query module 21 stores the input sequence I2 and its complementary data. Each random bit sequence represents an input sequence I2 without further processing. Before the encryption of the input sequence I2 is carried out a hash method h₁ is utilized whereby a hashed sequence I2(h₁) is calculated. This hashed identification sequence I2(h₁) is then encrypted by means of the encryption method E1 with a secret key Kᵢ where after the unique product-inspection sequence I3 is received. In a next step the identification sequence I3 is converted by means of a second hash method h into a hashed identification sequence I3(h₂). The unique product-inspection sequence I4 is then calculated as product of the hashed identification sequence I3(h₂) and the product-individual sequence I1. Because the unique product-inspection sequence I4 represents in this sample a bit sequence it can be delivered with the product for example stored on a radio frequency identification (RFID) tag, a magnetic stripe, a memory chip or a digital media for example a DVD.

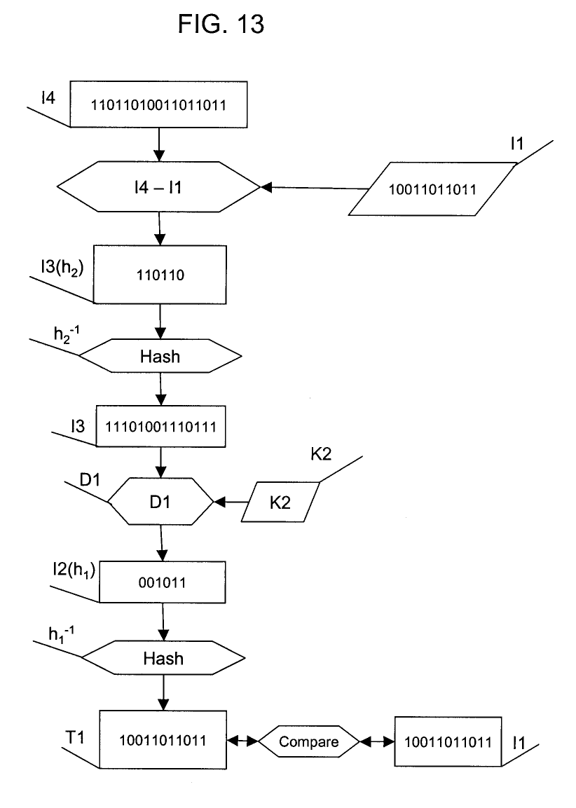

FIG. 13 shows a variant where the unique product-inspection sequence I4 is completely inversed to verify its consistency. Because the unique product-inspection sequence I4 is a bit sequence it can retrieved automatically and the whole process for the proof of authenticity can carried out without manual intervention.

At first the hashed identification sequence I3(h₂) is calculated by subtraction the product-individual sequence I1 from the unique product-inspection sequence I4. The product-individual sequence I1 can be retrieved from a log file 7 where the complementary data of the appropriate unique product-inspection sequence I4 is stored. In a next step for the hashed identification sequence I3(h₂) a hash inverse function h₂⁻¹ is carried out whereby the encoded identification sequence I3 is retrieved. Then the decoding of the identification sequence I3 is carried out with help of the decryption method D1 using a decryption key K2, whereby the hashed sequence I2(h₁) is retrieved. After that a hash inverse function h₁⁻¹ is carried out for the hashed sequence I2(h₁) the test sequence T1 is received as result. The test sequence T1 and the product-individual sequence I1 retrieved from a log file 7 as complementary data to the appropriate unique product-inspection sequence I4 is compared.

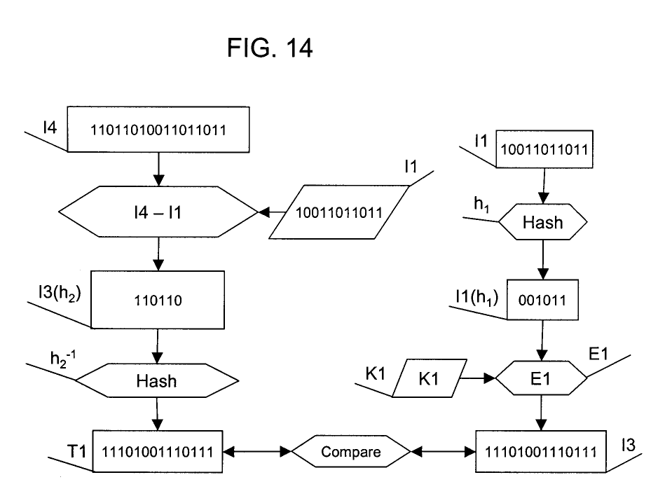

Flow chart FIG. 14 shows a variant where the consistency of a unique product-inspection sequence I4 is tested by partially decrypting a unique product-inspection sequence I4 and partially encrypting a product-individual sequence I1. In a first step the hashed identification sequence I3(h₂) is calculated by subtraction the product-individual sequence I1 from the unique product-inspection sequence I4. After that for the hashed identification sequence I3(h₂) a hash inverse function h is carried out where the encoded test sequence T1 is retrieved. In a second step the product-individual sequence I1 is retrieved as complementary data of the unique product-inspection sequence I4 from a log file 7 and processed by carrying out a hash method h₁ whereby the hashed sequence I1(h₁) is calculated. This hashed identification sequence I1(h₁) is then encrypted by means of the encryption method E1 by using the key K1 to receive the product-inspection sequence I3. The consistency of the unique product-inspection sequence I4 is now compared by verifying if the test sequence T1 is equal the calculated product-inspection sequence I3.

In case the compared sequences matches it concerns a valid unique product-inspection sequence I4, while in case of discrepancy a falsified unique product-inspection sequence I4 is present. For determining the authenticity of a product after the product-inspection sequence I4 is confirmed as consistent the test sequence T1 is forwarded to carry out comparison and logical tests as shown in FIG. 2.

1. What is claimed is:
A system of protecting products against counterfeiting compromising the steps:
a) encoding a sequence by using a computer system;
b) method to assure that only unique sequences are calculated;
c) delivering the said sequence with a product;
d) transmit said sequence to a computer system;
e) verify said sequence by using a computer system to identify the consistency of said sequence;
f) verify said sequence with data stored on a said computer system to determine a product as original or as falsification;
g) report the result of verification.

2. A computer system of claim 1 to:
a) encode sequences and;
b) decode sequences and;
c) carry out tests of the consistency of encoded sequences and;
d) carry out comparison of said sequences with stored data on said computer system and;
e) store data on said computer system and;
f) legitimize parties to access the said computer system and;
g) legitimize parties to process data on the said computer system and;
h) generate and send messages.

3. A method of claim 1 of calculating the said encoded sequence by utilizing:
a) a symmetric encryption method or;
b) an asymmetric encryption method or;
c) by utilizing in addition a hash method to a symmetric encryption method or;
d) by utilizing in addition a hash method to an asymmetric encryption method.

4. Mthod sof claim 1 to assure that only unique encoded sequences are calculated.

5. A method to control manufacturer for producing the same number of products as ordered by a customer by using encoded sequences and deliver the same number of encoded sequences to a manufacturer as number of products are ordered by a customer.

6. A method of protecting products against counterfeiting by delivering an encoded sequence with each piece of product whereby the sequence:
a) is printed in readable form on the product or;
b) is engraved in readable form on the product or;
c) is printed as barcode on the product or;
d) is printed in readable form at the package of the product or;
e) is printed in readable form on a label that can be affixed to the product or the package of the product or;
f) is printed in readable form on a leaflet that is delivered with the product or;
g) is engraved as barcode on the product or;
h) is printed as barcode on the package of the product or;
i) is printed as barcode on a label that can be affixed to the product or the package of the product or;
j) is printed as barcode on a leaflet, which is delivered with the product or;
k) Is stored on a magnetic stripe that is delivered with the product or;
l) is stored on a radio frequency identification (RFID) tag that is delivered with the product or;
m) is stored on a the read only memory chip (ROM) in addition to the user data or;
n) is stored on a chip that is built in a product or;
o) is stored on any kind of digital data media or;
p) is stored on a compact disc-read (CD) or;
q) is stored on a digital versatile disc (DVD) or;

7. A method of proofing the authenticity of products by verifying the consistency of encoded sequences according claim 3 which are delivered with each piece of product by carrying out:
a) a symmetric encryption method;
b) a symmetric decryption method;
c) an asymmetric encryption method;
d) an asymmetric decryption method;
e) a symmetric encryption method and a hash method;
f) a symmetric decryption method and a hash method;
g) an asymmetric encryption method and a hash method;
h) an asymmetric decryption method and a hash method.

8. A method of determining products as original or as falsification by utilizing comparisons with data stored in files on computer systems according claim 2 when performing a proof of authenticity.

9. A method of determining the current place where a proof of authenticity of a product is carried out by using encoded sequences and computer systems according claim 2 and data stored in log files on computer systems according claim 2.

10. A method of tracing the chain of distribution of products by using encoded sequences and computer systems according claim 2 and data stored in log files on computer systems according claim 2 when performing proofs of authenticity.
